(19) United States
(12) Patent Application Publication
(10) Pub. No.: US 2026/0219672 A1
(43) Pub. Date: Jul. 30, 2026

(54) MOBILE ROBOT

(71) Applicant: THK CO., LTD., Tokyo (JP)

(72) Inventors: Kaoru Hoshide, Minato-ku, Tokyo (JP); Jun Kawasaki, Minato-ku, Tokyo (JP); Masaki Shibuya, Minato-ku, Tokyo (JP); Norimasa Okada, Minato-ku, Tokyo (JP)

(73) Assignee: THK CO., LTD., Tokyo (JP)

(21) Appl. No.: 19/143,041

(22) PCT Filed: Dec. 22, 2023
(86) PCT No.: PCT/JP2023/046099

§ 371 Date: Jun. 25, 2025

(30) Foreign Application Priority Data
Dec. 26, 2022 (JP) 2022-208467

(51) Int. Cl. G05D 1/617; B64U 10/14; B64U 50/13; B64U 60/50; G05D 109/25

(52) U.S. Cl. CPC G05D 1/617; B64U 10/14; B64U 50/13; B64U 60/50; G05D 2109/254

(57) ABSTRACT

A mobile robot includes a main body portion having a plurality of propulsion units each configured to generate a propulsion force by driving a rotary wing, and a plurality of support portions that are provided on the main body portion and are capable of supporting at least a part of the main body portion by being in contact with a predetermined contact surface, wherein when movement control of the robot is performed while supporting the main body portion by the plurality of support portions, a load applied to the predetermined contact surface is adjusted, in assist control for the movement control, by driving the plurality of propulsion units via predetermined support portions in contact with the predetermined contact surface.

### TECHNICAL FIELD

The present invention relates to a mobile robot that is capable of flight and movement motion.

### BACKGROUND ART

In recent years, unmanned aerial vehicles have been used for various purposes, and their development has been actively pursued. As the unmanned aerial vehicles, there are used radio-controlled unmanned helicopters or so-called drones. For example, examples of the use of drones for agricultural purposes include spraying agricultural chemicals, observing the growth of crops using onboard cameras, and generating air currents to protect crops from frost damage (see, for example, Patent Literature 1). Further, robots capable of flight with arms or the like for performing a predetermined work installed on unmanned aerial vehicles have been developed so as to be widely used not only for agricultural purposes but also for other purposes (for example, see Patent Literature 2).

In addition, Patent Literature 3 discloses a mobile robot that performs a flight operation by propulsion units and a walking motion while being placed on the ground. In this mobile robot, walking is performed by two leg portions, and when an increased tilt or inclination of a main body portion of the robot is detected by a sensor during the walking motion, the posture of the robot is controlled by using the propulsion units so that the inclination falls within a predetermined angle range.

### CITATION LIST

### Patent Literature

Patent Literature 1: Japanese Patent Application Laid-Open Publication No. 2018-000015
Patent Literature 2: WO 2016/193666
Patent Literature 3: Japanese Patent No. 6733965

### SUMMARY OF INVENTION

### Technical Problem

In a case where the main body portion of the robot is moved in a state in which the robot is in contact with a contact surface such as the ground, i.e., in a case where the movement of the robot accompanied by contact with the contact surface such as walking is performed instead of its movement by flight (in the present application, the former form of movement is referred to as “flight movement” and the latter form of movement is referred to as “contact movement”), the main body portion of the robot needs to realize its movement while being supported by support portions (e.g., leg portions) in contact with the contact surface so as to prevent the main body portion from tipping over. In general, in the contact movement, when the speed of the movement is rapid, it becomes difficult to maintain the stability of the robot main body, thus increasing the possibility of tipping over. In addition, the main body portion of the robot will swing as it moves, which inhibits the acquisition of information about the position and posture of the robot, which is necessary for stable contact movement of the robot, thus resulting in that the possibility of the robot main body portion tipping over cannot be eliminated.

The present invention has been made in view of the above-mentioned problems, and an object of the present invention is to provide a robot technology in which, in a robot that performs contact movement with a contact surface, stable contact movement is realized by avoiding a main body portion of the robot from tipping over as much as possible.

### Solution to Problem

In the present invention, in order to solve the above-mentioned problems, a robot according to the present invention is provided with support portions that come into contact with a contact surface, and a configuration is adopted in which the propulsion forces of propulsion units are controlled. In addition to this, the robot is provided with a first controller for contact movement when the contact movement is performed using the support portions, and a second controller configured to perform assist control for assisting the contact movement using the propulsion units. With such a configuration, it is possible to realize stable contact movement in the robot.

In detail, a mobile robot according to the present invention includes: a main body portion having a plurality of propulsion units each configured to generate a propulsion force by driving of a rotary wing; a plurality of support portions provided on the main body portion and configured to come into contact with a predetermined contact surface to be capable of supporting at least a part of the main body portion; a first controller configured to perform movement control in which the main body portion moves on the predetermined contact surface by the plurality of support portions while supporting the main body portion by the plurality of support portions; and a second controller configured to perform assist control for the movement control by the first controller using a part or all of the plurality of propulsion units. Then, the second controller drives the plurality of propulsion units in the assist control to adjust a load applied to the predetermined contact surface via predetermined support portions in contact with the predetermined contact surface among the plurality of support portions.

### Advantageous Effects of Invention

In a mobile robot that moves in contact with a contact surface, it is possible to avoid its main body portion from tipping over as much as possible thereby to realize stable contact movement.

### BRIEF DESCRIPTION OF DRAWINGS

FIG. 1 is a view illustrating a schematic configuration of a mobile robot according to an embodiment.

FIG. 2 is a functional block diagram illustrating an image of functional units formed in the mobile robot according to the embodiment.

FIG. 3 is first views for explaining assist control for assisting walking of the mobile robot.

FIG. 4 is a second view for explaining assist control for assisting walking of the mobile robot.

FIG. 5 is a flowchart related to assist control for assisting walking of the mobile robot.

FIG. 6 is views illustrating a first form in which assist control for walking of a mobile robot is performed.

FIG. 7 is views illustrating a second form in which assist control for walking of a mobile robot is performed.

### DESCRIPTION OF EMBODIMENTS

A mobile robot of the present embodiment can generate a propulsion force for raising or lowering a main body portion thereof by a plurality of propulsion units provided at a main body portion side. Each of the propulsion units has a rotary wing, and a propulsion force generated by each propulsion unit is determined by rotationally driving the corresponding rotary wing. Preferably, the propulsion forces of the respective propulsion units can be controlled independently. The arrangement of the plurality of propulsion units on the main body portion can be designed in an optional manner. The mobile robot may be configured to be capable of flying (ascending, descending, turning, etc.) by balancing the propulsion forces of the respective propulsion units provided on the main body portion. The plurality of propulsion units provided on the main body portion may all be of the same type or may be a mixture of different types.

Then, the mobile robot is equipped with a plurality of support portions, so that its main body portion is supported against a predetermined contact surface. Note that the support of the main body portion by the support portions may be in the vertical direction, or may be in a direction other than the vertical direction. In the former case, the support portions may be configured as leg portions that come into contact with the contact surface to allow the main body portion to walk thereon. In the latter case, the support portions can be configured as arm portions that serve to enable the main body portion to be moved while contacting and gripping the contact surface. As the configurations of the support portions, other ones than these configurations described above can also be adopted.

Here, in the mobile robot, the first controller controls to execute contact movement in which the mobile robot moves on the contact surface using the plurality of support portions. The first controller controls the driving of the plurality of support portions so as to prevent the main body portion from coming into contact with the contact surface due to tipping over, i.e., to perform contact movement while maintaining support by the support portions. Here, when the control by the first controller is being performed, the contact between a part of the plurality of support portions and the contact surface may be momentarily or temporarily eliminated, so that the stability of the support of the main body portion by the plurality of support portions may be reduced. Such a reduction in stability does not necessarily result in the mobile robot toppling over, but it is preferable that the degree of the reduction be as small as possible. In particular, if it is difficult to predict the condition of the contact surface with which the support portions come into contact, the possibility of tipping over is increased due to the inability of the first controller to provide good control of the movement.

Therefore, when the possibility of such tipping over increases, assist control for movement control is performed by a second controller. In the assist control, the load transmitted to the contact surface via the support portions in contact with the contact surface is adjusted by the use of the propulsion forces of the plurality of propulsion units. That is, by intentionally adjusting the load applied through each support portion, the position of the center of pressure of the support portions of the mobile robot against the contact surface is shifted to a state where tipping over is unlikely to occur. This serves the purpose of avoiding tipping over.

More specifically, the second controller may adjust the load such that the target pressure position is displaced to the inside of an actual support region when the target pressure position related to the shift of the center of gravity of the main body portion in the movement control is not inside the actual support region in which the main body portion is actually supported by predetermined support portions. In the assist control, when a target pressure position is not inside an actual support region, it is considered that a support force by the support portions required for stable contact movement is insufficient, thus increasing the possibility of tipping over. The target pressure position is a position of a zero moment point (ZMP) of the mobile robot, which is assumed when the first controller performs the contact movement. The actual support region is a region on the contact surface, which is defined by the contact parts of those support portions which are in contact with the contact surface among the plurality of support portions. In this way, in a case where it is considered that there is a high possibility of tipping over based on a correlation between the target pressure position and the actual support region, the propulsion forces generated by driving a part or all of the plurality of propulsion units are used to displace the ZMP of the mobile robot from a position corresponding to the initial target pressure position (i.e. a position outside the actual support region) to a position according to the load adjustment (i.e. a position within the actual support region), thereby avoiding the mobile robot from tipping over.

Thus, when it is determined that the possibility of tipping over is high, the load adjustment is performed by using the propulsion forces of the propulsion units, whereby it is possible to accurately provide the assistive support force for preventing the mobile robot from tipping over regardless of the movement or the posture/position of the support portions. This simplifies the configuration for prevention of tipping over in the mobile robot, and hence, for example, the arrangement of sensors or the like for smooth contact movement can be omitted. Further, even if the state of the contact surface is not as expected, the assistive support force can be accurately generated by suitably driving the propulsion units, thus making it possible to realize stable contact movement.

Hereinafter, specific embodiments of the present Invention will be described based on the accompanying drawings. The dimensions, materials, shapes, numbers, relative arrangements, and the like of component parts described in the embodiments are not intended to limit the technical scope of the present invention to only those unless otherwise described.

### Embodiment

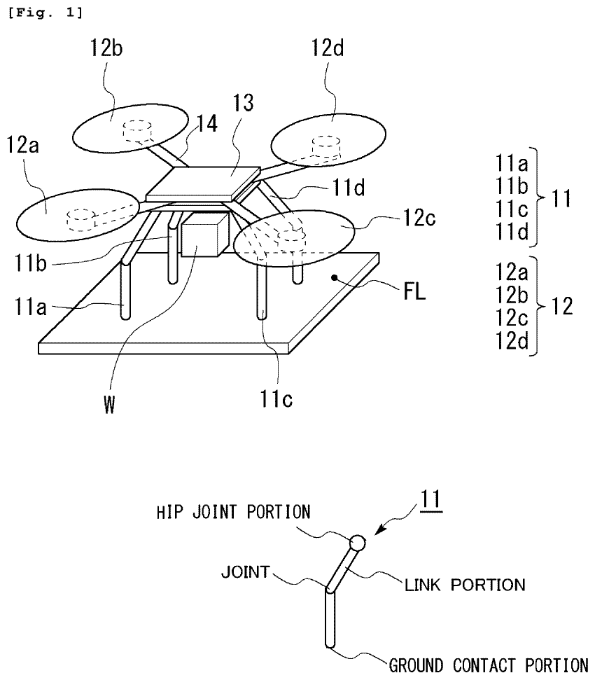

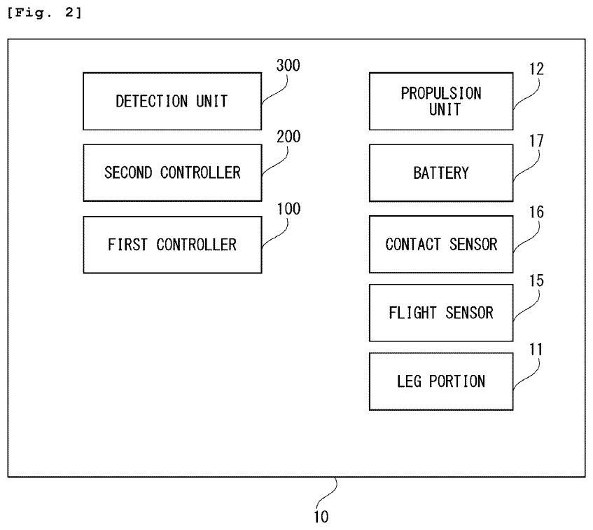

Here, an outline of a mobile robot 10 according to the present embodiment will be described based on FIGS. 1 and 2. FIG. 1 is a view illustrating an external appearance configuration of the mobile robot 10, and FIG. 2 is a diagram illustrating functional blocks included in the mobile robot 10. A main body portion 13 of the mobile robot 10 includes a portion mainly related to a flight motion of the mobile robot 10, and a portion mainly related to a walking motion of the mobile robot 10. That is, in the present embodiment, the mobile robot 10 is configured to be capable of realizing the flight motion and the walking motion.

First, a structure related to a flight motion will be described. A plurality of propulsion units 12 are arranged on the main body portion 13 via a plurality of bridge members 14. Note that in the example illustrated in FIG. 1, four propulsion units 12 are mounted on the main body portion 13, but as long as the flight of the mobile robot 10 is possible, the number of propulsion units 12 mounted thereon is not limited to four as long as it is plural. In addition, in the present embodiment, when the mobile robot 10 is in a reference posture with respect to the contact surface (e.g., the ground or the like) FL, a rotor plane formed by connecting the center points of the four propulsion units is parallel to the contact surface FL, and the four propulsion units 12 are respectively arranged in rotational symmetry around the main body portion 13 on the rotor plane. In other words, the four propulsion units 12 are arranged on the plane B in line symmetry with respect to a predetermined center line or in point symmetry with respect to a predetermined point. Here, note that in the reference posture, all of the four leg portions 11 to be described later are in a predetermined state so that the main body portion 13 is not inclined with respect to the contact surface FL. Note also that when the propulsion units 12 are individually referred to, reference signs 12a through 12d are used.

The propulsion units 12 each include a propeller, which is a rotary wing, and an actuator for rotationally driving the propeller. All the four propulsion units 12 are of the same type, but the actuators in the respective propulsion units 12 can be controlled independently. Therefore, it is possible to appropriately control the propulsion force obtained by each propulsion unit 12, and thus it becomes possible to appropriately control the flight posture, the flight speed, and the like of the mobile robot 10. Further, as will be described later, in the assist control when the mobile robot 10 is performing a walking motion, too, the actuators can be independently controlled in the respective propulsion units 12. In addition, the mobile robot 10 is equipped with a sensor (flight sensor) 15 necessary for its flight motion, sensors (contact sensors) 16 necessary for its walking motion, a battery 17 (see FIG. 2) for supplying drive power to the sensors and the actuator of each propulsion unit 12, and a control device for controlling the power supply from the battery 17 to each actuator. In the control device, two controllers, a first controller 100 and a second controller 200, are incorporated, and details thereof will be described later.

Next, a structure related to the walking motion will be described. The mobile robot 10 has leg portions 11 (four legs) configured to be capable of executing the walking motion. Note that in the example illustrated in FIG. 1, four leg portions 11 are provided on the main body portion 13, but the number of the leg portions 11 is not limited to four as long as the walking motion is possible, and two or three leg portions 11 may be provided, or five or more leg portions 11 may be provided. Note that in a case where the leg portions 11 are individually referred to, reference signs 11a through 11d are used.

As an example of the leg portions 11, an enlarged view of a leg portion 11 is illustrated in FIG. 1. The leg portions 11 each have a ground contact portion that comes in contact with the ground when the mobile robot 10 walks by walking motion, a link portion that is relatively rotatably connected to the ground contact portion via a joint, a hip joint portion that is relatively rotatably connected to the link portion via a joint, and a plurality of actuators (not illustrated) that drive and control the rotation of each joint. The joint related to the link portion is designed for its rotational directions (i.e., rotational directions around a roll axis and a pitch axis) according to the walking motion to be assumed. Note that the configuration of each leg portion 11 is not limited to such an example. In addition, each hip joint portion is connected to a lower side of the main body portion 13 via a predetermined joint so as to be relatively rotatable. This predetermined joint is configured to be rotatable about a yaw axis. The predetermined joint may also be configured to be rotatable about a roll axis and a pitch axis.

The leg portions 11 configured as described above are a structure that enables the walking motion of the mobile robot 10 while supporting the self-weight of the mobile robot against the contact surface FL in the walking motion of the mobile robot 10. Therefore, the four leg portions 11 function as the support portions of the present invention for realizing the walking motion included in the type of the movement motion. In addition, unlike the flight motion, the movement of the mobile robot is performed in a state in which at least one of the four leg portions 11 is in contact with the contact surface FL to support the main body portion 13. Therefore, the walking motion is also one form of motion included in the contact movement.

### <Control Unit of Mobile Robot 10>

Next, the control configuration of the mobile robot 10 will be described based on FIG. 2. The mobile robot 10 has a control device including a first controller 100, a second controller 200, and a detection unit 300. The control device is a computer having an arithmetic processing unit and memory. Each functional unit is formed by executing a predetermined control program in the mobile robot 10.

First, the first controller 100 will be described. The first controller 100 is a functional unit for performing a walking motion and a flight motion in the mobile robot 10 using the leg portions 11 and the propulsion units 12. That is, the first controller 100 controls the actuators provided on the leg portions 11 for the walking motion, and further controls the propulsion units 12 for the flight motion. The first controller 100 controls the propulsion forces of the four propulsion units 12 based on environmental information, which is information related to the flight state of the mobile robot 10 and is detected by the flight sensor 15. As such environmental information, there can be exemplified information about an angular velocity of the main body portion 13 detected by a gyro sensor corresponding to unillustrated three axes (a yaw axis, a pitch axis, and a roll axis), a tilt or inclination of the main body portion 13 detected by an acceleration sensor corresponding to the same unillustrated three axes, and the like. The first controller 100 performs feedback control using the environmental information acquired from these sensors so that the tilt of the main body portion 13 of the mobile robot 10 is in a state suitable for flight. Further, the environmental information may include an azimuth angle which is the orientation of the main body portion 13 (i.e., the orientation of the main body portion of the mobile robot 10) in the absolute coordinate system when the orientation of the earth's axis is set as a reference, and the azimuth angle can be detected by an azimuth angle sensor.

Here, in a case where the main body portion 13 of the mobile robot 10 is caused to fly forward, backward, leftward, and rightward, the first controller 100 decreases the number of revolutions of the actuator of a propulsion unit 12 in the direction of travel and increases the number of revolutions of the actuator of a propulsion unit 12 on the side opposite to the direction of travel, so that the main body portion of the mobile robot 10 takes a forward-leaning posture with respect to the direction of travel, thus traveling in a desired direction. Also, in a case where the main body portion of the mobile robot 10 is caused to rotate and fly, the first controller 100 provides the output of each propeller 21 according to the direction of rotation thereof based on the direction of rotation of the main body portion 13 of the mobile robot 10. For example, when turning the main body portion 13 of the mobile robot 10 to the right, the first controller 100 decreases the output of the actuator corresponding to the propeller that is rotating to the right, and increases the output of the actuator corresponding to the propeller that is rotating to the left.

Further, a walking motion performed by the first controller 100 will be described. The first controller 100 is also a functional unit that, when the mobile robot 10 walks, controls an actuator provided on each of the four leg portions 11 for the walking. The first controller 100 uses environmental information, detected by the contact sensors 16, that indicates whether or not the ground contact portion of each leg portion 11 is in contact with the contact surface FL, when the walking motion is performed. Note that, in the present embodiment, a predetermined walking control program for walking on the contact surface FL, which is used by the first controller 100, utilizes detection values of the contact sensors 16 by reducing the acquisition of information about the surrounding environment of the mobile robot 10 as much as possible in order to make the walking control of the mobile robot 10 simpler and easier.

More specifically, the actuator provided on each joint of the leg portions 11 is provided with an encoder (not illustrated) that detects state quantities (a rotation position, a rotation speed, and the like of a rotation shaft of the actuator) related to each rotation state. Note that a sensor other than the encoder may be used. Then, the first controller 100 performs feedback control on the actuators of the leg portions 11 based on the state quantities of each actuator detected by the encoder of the actuator so that the walking motion of the mobile robot 10 is realized in accordance with a movement instruction provided to the mobile robot 10. As described above, in the present embodiment, the feedback control of the actuators makes as little use of environmental information outside the robot as possible. This makes it possible to omit the sensors to be mounted on the mobile robot 10 as much as possible and to simplify the walking control itself.

Further, during the walking control, the contact sensors 16 detect whether or not the ground contact portions of the respective leg portions 11 are in contact with the contact surface FL. The fact that a leg portion 11 is not in contact with the contact surface FL means that the main body portion 13 of the mobile robot 10 is not supported by a reaction force from the contact surface FL via that leg portion 11. Thus, if the main body portion 13 of the mobile robot 10 is not supported by the leg portion 11, the stability of the main body portion 13 can change, and in some cases, the possibility of the main body portion 13 tipping over increases. In such a case, in the present embodiment, the assist control by the second controller 200 (corresponding to “assist control for walking control” according to the present invention) is performed.

### <Assist Control>

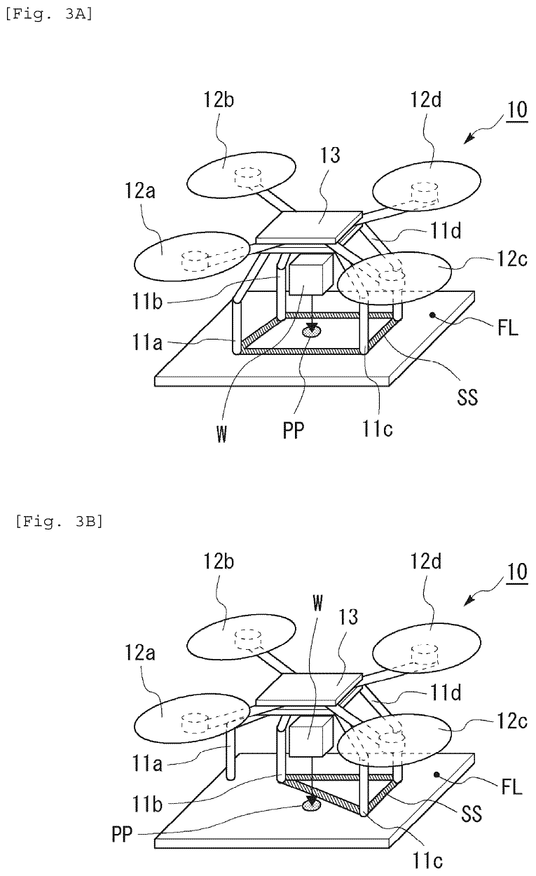

Hereinafter, the assist control by the second controller 200 will be described. Here, a change in the stability of the main body portion 13 during the walking control (when the mobile robot 10 is performing the walking motion) will be described based on FIG. 3. For simplicity of description, it is assumed that the mobile robot 10 is in a static state. In a case where the mobile robot 10 is in a dynamic state, i.e., in a case where it is subjected to an acceleration/deceleration, disturbance or the like, a necessary force and/or torque is taken into consideration in addition to gravity. The upper part (a) of FIG. 3 indicates a state in which the four leg portions 11 of the mobile robot 10 are in contact with the contact surface FL, and the lower part (b) thereof indicates a state in which one leg portion 11a among the four leg portions 11 is separated or away from the contact surface FL. The state in which the leg portion 11a is separated from the contact surface FL is detected by the contact sensor 16 of the leg portion 11a. Here, it is assumed that the mobile robot 10 is performing a walking motion with a workpiece W mounted thereon.

Here, for the leg portions 11 whose ground contact portions are actually in contact with the contact surface FL, a closed region, which is formed so as to include the contact points, is defined as an actual support region SS. As an example, the actual support region Ss may be a polygonal region having the contact points as vertexes. In this case, in FIG. 3 (a), the actual support region SS is formed in a quadrangular shape, and in FIG. 3 (b), the actual support region Ss is formed in a triangular shape. In addition, from the viewpoint of suitably supporting the mobile robot 10, the actual support region SS may be formed in shapes further reduced to the inside with respect to the forms shown in FIGS. 3 (a) and (b). Note that the second controller 200 can determine the position of the contact point of each leg portion 11 from the detection value of each contact sensor 16 and the state (position) of the actuator of each leg portion 11 when the contact state thereof is detected.

Then, in a case where the mobile robot 10 performs walking control using the four leg portions 11, a trajectory on which the center of gravity of the mobile robot 10 should be located during the walking motion is given as a position command to the first controller 100, and each leg portion 11 is driven so as to follow the position command. At this time, the position of an ideal ZMP calculated from the trajectory or the like of the mobile robot 10 is defined as a target pressure position PP. The load of the workpiece W carried by the mobile robot 10 is also taken into consideration for the target pressure position PP. Then, during the walking control, as illustrated in FIG. 3 (a), when the target pressure position PP is located inside the actual support region SS, the mobile robot 10 is stably supported by the four leg portions 11. On the other hand, as illustrated in FIG. 3 (b), when the target pressure position PP is not located inside the actual support region Ss, the mobile robot 10 is not stably supported by the three leg portions 11b, 11c, 11d. Accordingly, in this case, the mobile robot 10 may tip over.

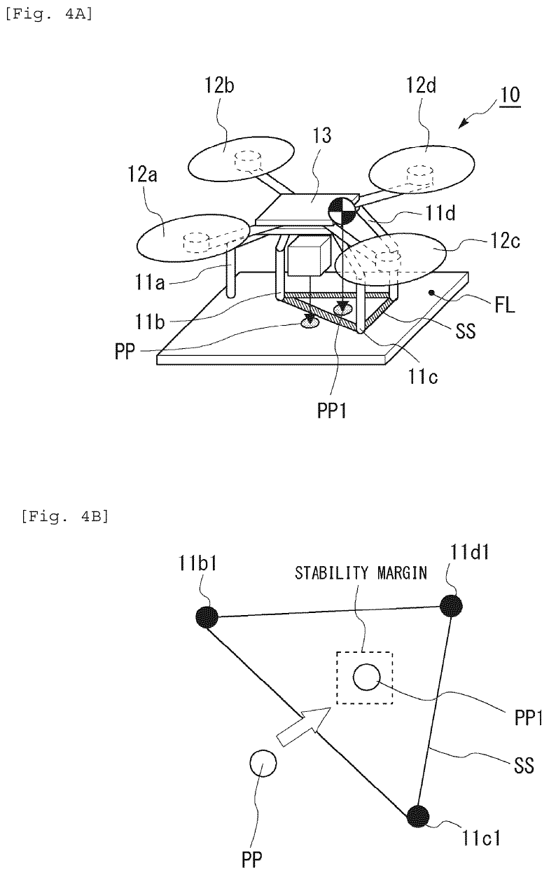

Therefore, in order to suppress tipping over that may occur due to the target pressure position PP deviating from the actual support region Ss in this manner, in the present embodiment, four propulsion units 12 are used to adjust the load via the leg portions 11 in contact with the contact surface FL. As a result of the load adjustment, the actual position of the center of pressure of the mobile robot 10 relative to the contact surface FL is displaced, whereby the target pressure position PP is displaced to the inside of the actual support region SS, thereby preventing the mobile robot 10 from tipping over. This load adjustment will be described based on FIG. 4. The state of the mobile robot 10 illustrated in the upper part (a) of FIG. 4 is the same as that illustrated in FIG. 3 (b), and the leg portions 11b, 11c, 11d are in contact with the contact surface FL, and a triangular actual support region Ss is formed by connecting the respective contact points 11b1, 11c1, 11d1. The target pressure position PP is located outside the actual support region SS.

In addition, the lower part (b) of FIG. 4 is a view of the contact surface FL as seen from above, illustrating the correlation between the actual support region SS and the target pressure position PP. In the load adjustment for the assist control, the drive control of the four propulsion units 12 is performed so that the target pressure position PP, which is outside the actual support region SS, falls within the actual support region SS. In FIG. 4 (b), the target pressure position after the load adjustment is represented by PP1. Note that at this time, it is preferable to provide a certain degree of margin (stability margin) so that the adjusted target pressure position PP1 does not immediately deviate from the actual support region due to external disturbance or the like. That is, the load adjustment is performed so that a section having a certain size centered on the target pressure position itself falls within the actual support region SS.

More specifically, since the total sum of the reaction forces transmitted from the contact surface to the leg portions 11 and the load increased or decreased by the propulsion units 12 is equal to the gravity, following Formula 1 holds. The load increased or decreased by the propulsion units 12 is regarded as an increase or decrease in the virtual weight (mass) of the mobile robot 10, and is referred to as “a gravity load due to the virtual mass”.

$$\begin{matrix}[ Math . 1 ] & \\ {f}_{a l l} = 0 = {\sum }_{i = 1}^{4} {f}_{R í} + {\sum }_{i = 1}^{n} {f}_{VgAi} - mg = {\sum }_{i = 1}^{4} {f}_{Ri} + \sum {f}_{r i} - mg & ( Formula 1 )\end{matrix}$$

where fRi represents a reaction force transmitted to each leg portion 11, fVgAi represents the gravity load due to the above-mentioned virtual mass, and fRi represents a rotor thrust force.

Further, from the balance of the moment around the center of gravity of the mobile robot 10, following Formula 2 holds.

$$\begin{matrix}[ Math . 2 ] & \\ \begin{matrix}{M}_{a l l} = 0 = {\sum }_{i = 1}^{4} {r}_{R i} \times {f}_{R i} + {\sum }_{i = 1}^{4} {r}_{r i} \times {f}_{r i} \\ = {\sum }_{i = 1}^{4} {r}_{R i} \times {f}_{Ri} + {\sum }_{i = 1}^{4} {r}_{VgAi} \times {f}_{VgAi}\end{matrix} & ( Formula 2 )\end{matrix}$$

where rRi represents the position of the ground contact portion of each leg portion, and rri represents the position of each propulsion unit 12. In addition, rVgAi represents the position of the virtual mass.

Then, when the mobile robot 10 is in a static state, an average of the center of gravity (the center of gravity corresponding to the target pressure position PP) of the mobile robot 10 and the position of the virtual mass is the center of gravity of the mobile robot after load adjustment, and a point where it is projected onto the contact surface FL is the target pressure position PP1 after load adjustment. Thus, the load applied to the target pressure position PP1 is the sum of the self-weight of the mobile robot 10 and the gravity load due to the virtual mass. Based on the above, the gravity load due to the virtual mass and the position of the virtual mass are calculated so that Formula 1 and Formula 2 are satisfied and the target pressure position PP1 after load adjustment falls within the actual support region. Then, a rotor thrust force that can realize the virtual mass is calculated from Formula 2, and a drive command is issued to each propulsion unit 12. As a result, the assist control is executed by the second controller 200, and thus the stability of the walking motion of the mobile robot 10 is improved as compared with the case where the assist control is not executed. In addition, as described above, a stable walking motion is achieved, despite the fact that the number of sensors to be used is small, because the use of environmental information is suppressed as much as possible for the walking control of the mobile robot 10.

Next, the detection unit 300 will be described. The detection unit 300 is a functional unit that detects a friction condition on the contact surface FL, and for example, performs processing of images on the contact surface FL taken by a camera provided on the mobile robot 10 to grasp the degree of dryness and the condition on the surface of the contact surface FL, thus detecting the friction condition. In general, in a case where the contact surface FL is wet due to rain, snow, or the like, the coefficient of friction thereof with the mobile robot 10 will decrease, which may have some effect on stable walking motion. On the contrary, in a case where a highly viscous material is present on the contact surface FL, the coefficient of friction is excessively increased due to the influence of the material, which may also have some effect on stable walking motion.

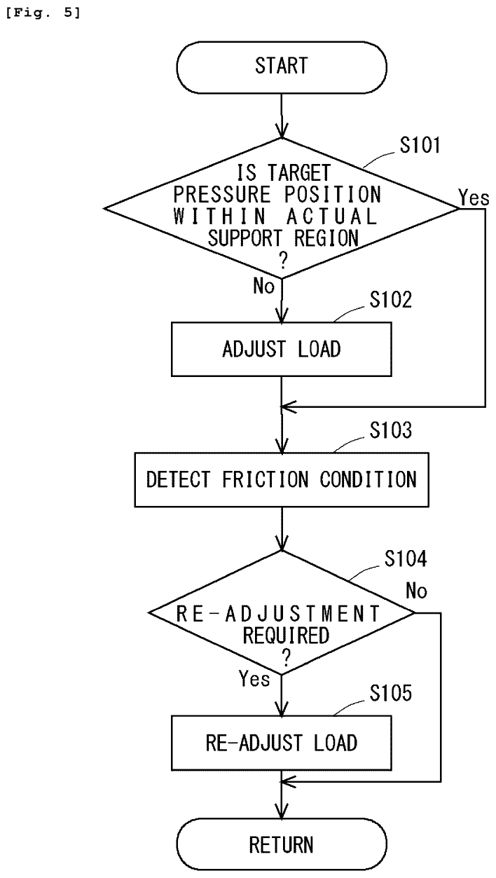

Therefore, the assist control based on the friction condition detected by the detection unit 300 will be described with reference to FIG. 5. The assist control illustrated in FIG. 5 is repeatedly executed by the second controller 200 at predetermined time intervals. First, in S101, it is determined whether or not the target pressure position PP at that time is inside the actual support region SS. In this determination, when an affirmative determination is made, the processing of S103 is performed, but when a negative determination is made, the processing of S102 is performed. Note that an example of the negative determination is the state illustrated in FIG. 4 (a). Then, in S102 after a negative determination is made, load adjustment is performed using the propulsion units 12, as described above, so that the adjusted target pressure position PP1 is placed inside the actual support region ss, as illustrated in FIG. 4 (b).

Subsequently, in S103, the detection unit 300 detects the friction condition on the contact surface FL. As for the detection of the friction condition, as described above, through image processing of the result of imaging by the camera, it is determined whether there is any water or snow on the contact surface FL that could cause the robot to tip over, or whether there is adhesion of any substance or the like on the contact surface FL that could cause increased friction. Then, in S104, it is determined, based on the friction condition obtained from the imaging result, whether or not re-adjustment of the load is required. That is, if the friction condition detected by the detection unit 300 differs from an expected friction condition by a predetermined threshold value or more, it will be considered that the difference may have a non-negligible effect on the walking motion of the mobile robot 10. Therefore, in such a case, it is determined that not only the load adjustment in S102 but also the re-adjustment of the load is required (affirmative determination).

When an affirmative determination is made in S104, the process proceeds to S105, where the re-adjustment of the load is performed by using the propulsion units 12. The load re-adjustment performed in S105 is a load adjustment overlaid on the load adjustment performed in S102. For example, based on the difference in the friction condition obtained as a result of the detection by the detection unit 300, the gravity load due to the virtual mass and the position of the virtual mass, which should be increased to ensure the friction force as expected, are calculated. At this time, it should be noted that the target pressure position after the re-adjustment is inside the actual support region SS. When processing in S105 ends, the assist control illustrated in FIG. 5 is repeated from the beginning. Thus, according to the assist control illustrated in FIG. 5, the walking control of the mobile robot 10 is assisted in consideration of the condition of the contact surface FL, so that the stability of the walking motion of the mobile robot 10 is further improved.

### Modified Embodiment 1

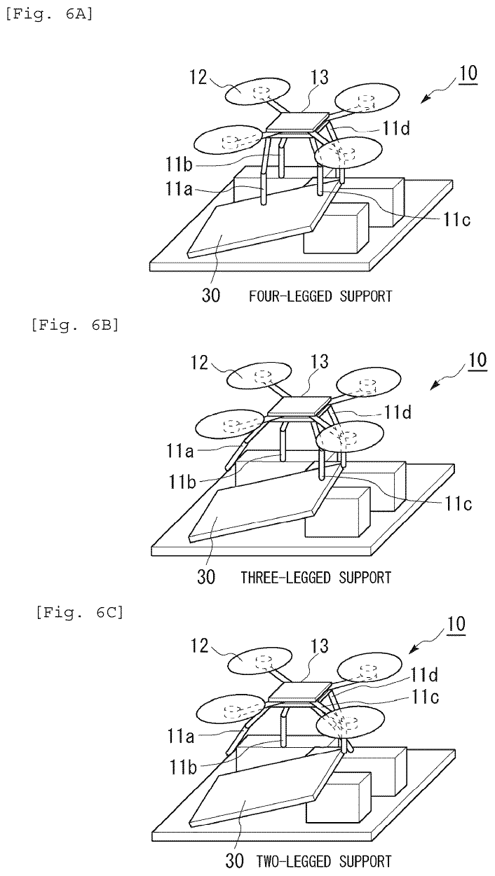

A first form of the support state by the leg portions 11 during the walking motion of the mobile robot 10 will be described based on FIG. 6. Note that in FIG. 6, the motion of walking is performed on a contact surface that is not a flat surface but is in a so-called uneven ground state. The upper part (a) of FIG. 6 discloses a state in which the main body portion 13 of the mobile robot 10 is supported by using all of the four leg portions 11. In addition, the middle part (b) discloses a state in which three leg portions 11 among the four leg portions 11 are used to support the main body portion 13 of the mobile robot 10, and specifically, the leg portion 11a is separated from the contact surface, and the main body portion 13 is supported by the other leg portions 11b, 11c, 11d. Also, the lower part (c) discloses a state in which the main body portion 13 of the mobile robot 10 is supported by using two leg portions 11 among the four leg portions 11, and specifically, the leg portions 11a, 11c are separated from the contact surface, and the main body portion 13 is supported by the other leg portions 11b, 11d.

The state of being supported by the four leg portions 11 is the most stable state, but in the case where the contact surface is in the uneven ground state as in the present form, there is a possibility that the target pressure position PP deviates from the actual support region Ss due to tilting or inclination of the mobile robot 10 or the like. In such a case, the assist control for the walking control by the second controller 200 described above can be executed. In this regard, the same applies to the case of being supported by three leg portions 11.

Here, as illustrated in FIG. 6 (c), in the case of being supported by two leg portions 11, the actual support region Ss formed by the leg portions 11b, 11d in contact with the contact surface is a straight line region connecting their respective contact points. In such a case, when the target pressure position PP is on the straight line, it is determined that the target pressure position PP is inside the actual support region SS, and when the target pressure position PP deviates from the straight line, it is determined that the target pressure position PP is not inside the actual support region SS. Then, in the latter case, the assist control for the walking control by the second controller 200 described above may be executed.

The walking motion of the mobile robot 10 does not necessarily have to be walking using the four leg portions 11. For example, depending on the shape and slope of the contact surface, two leg portions 11a, 11c of the four leg portions 11 may be always kept separated from the contact surface, and the remaining two leg portions 11b, 11d may be used for walking. That is, the walking motion should be performed using the number of leg portions most suitable for the condition of the contact surface, and if the mobile robot 10 cannot be stably supported by those leg portions, the assist control for the walking control by the second controller 200 described above should be performed.

### Modified Embodiment 2

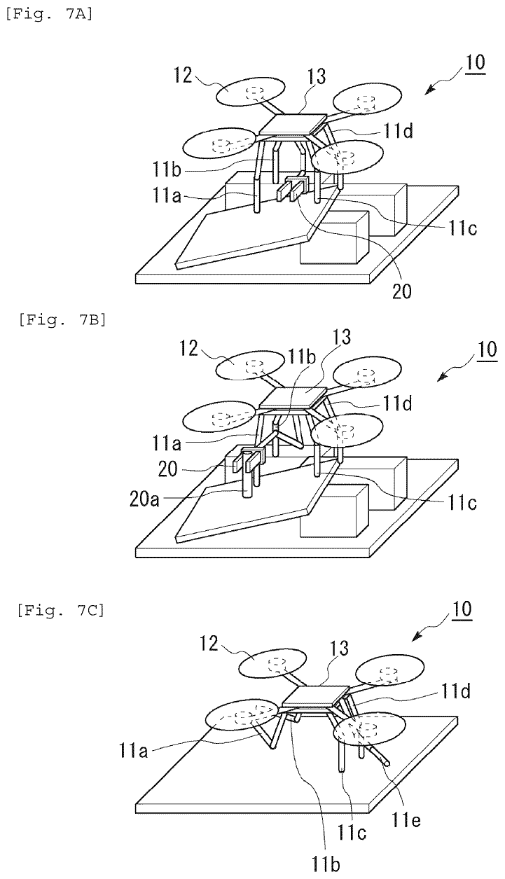

Next, a second form of the support state by the leg portions 11 at the time of the walking motion of the mobile robot 10 will be described based on FIG. 7. The upper part (a) of FIG. 7 discloses a state in which the main body portion 13 of the mobile robot 10 is supported by using all of the four legs 11 as well as an end effector 20, which originally has a holding or grasping mechanism for holding or grasping an object. The number of contact points for supporting the main body portion 13 is increased by the contact between the end effector 20 and the contact surface, so that the actual support region SS can be enlarged. This increases the chance that the target pressure position PP will be included in the actual support region SS, thereby achieving a more stable walking motion. Even in such a case, if the target pressure position PP deviates from the actual support region ss, the assist control for the walking control by the second controller 200 described above can be executed.

In addition, the middle part (b) discloses a state in which the main body portion 13 of the mobile robot 10 is supported by using an object 20a grasped or held by the end effector 20 in addition to all of the four leg portions 11. In this case, an actual support region SS will be formed by using a contact point between the object 20a held by the end effector 20 and the contact surface. For example, in a case where the mobile robot 10 walks while carrying the object 20a, a stable walking motion may be achieved by making use of the object. Even in such a case, if the target pressure position PP deviates from the actual support region SS, the assist control for the walking control by the second controller 200 described above can be executed.

Moreover, the lower part (c) discloses a state in which the main body portion 13 of the mobile robot 10 is supported by, in addition to two leg portions 11c, 11d among the four leg portions 11, using an auxiliary support portion 11e, which is not directly used for the walking motion unlike the leg portions 11 but is configured to be capable of supporting the main body portion 13 during the walking motion. The auxiliary support portion 11e is a structure that does not have a joint and an actuator for driving the joint as in the leg portions 11, but is configured to be capable of maintaining contact with the contact surface by applying a certain degree of load to the contact surface. In this case, too, an actual support region SS will be formed by using a contact point between the auxiliary support portion 11e and the contact surface. The support force of the auxiliary support portion 11e can, in some cases, be weaker than the support force by the leg portions 11, but for example, when comparing the case of walking with the two leg portions 11c, 11d and the case of walking by adding the auxiliary support portion 11e thereto, the actual support region SS can be enlarged in the latter case, thereby realizing a stable walking motion. Even in such a case, if the target pressure position PP deviates from the actual support region SS, the assist control for the walking control by the second controller 200 described above can be executed.

### REFERENCE SIGNS LIST

10 . . . mobile robot; 11, 11a, 11b, 11c, 11d . . . leg portions; 11e . . . auxiliary support portion; 12, 12a, 12b, 12c, 12d . . . propulsion units; 13 . . . main body portion; 14 . . . bridge members; 15 . . . flight sensor; 16 . . . contact sensor; 17 . . . battery; 20 . . . end effector; 20a . . . object; 100 . . . first controller; 200 . . . second controller; FL . . . contact surface; PP . . . target pressure position; SS . . . actual support region.

1. A mobile robot comprising:
a main body portion having a plurality of propulsion units each configured to generate a propulsion force by driving of a rotary wing;
a plurality of support portions provided on the main body portion and configured to come into contact with a predetermined contact surface to be capable of supporting at least a part of the main body portion;
a first controller configured to perform movement control for moving the main body portion on the predetermined contact surface by the plurality of support portions while supporting the main body portion by the plurality of support portions; and
a second controller configured to perform assist control for the movement control by the first controller by using a part or all of the plurality of propulsion units;
wherein the second controller drives the plurality of propulsion units in the assist control to adjust a load applied to the predetermined contact surface via predetermined support portions in contact with the predetermined contact surface among the plurality of support portions.

2. The mobile robot according to claim 1, wherein the second controller adjusts the load such that, when a target pressure position related to a shift in the center of gravity of the main body portion in the movement control is not inside an actual support region in which the main body portion is actually supported by the predetermined support portions, the target pressure position is displaced inside the actual support region.

3. The mobile robot according to claim 2, further comprising a detection unit configured to detect a friction condition on the predetermined contact surface, wherein the second controller adjusts the load based on the friction condition detected by the detection unit.

4. The mobile robot according to claim 1, wherein
in a case where the number of predetermined support portions in contact with the predetermined contact surface among the plurality of support portions is three or more, the actual support region is a polygonal region formed by connecting contact points between each of the predetermined support portions and the predetermined contact surface; and
in a case where the number of predetermined support portions in contact with the predetermined contact surface among the plurality of support portions is two, the actual support region is a straight line region formed by connecting contact points between each of the two predetermined support portions and the predetermined contact surface.

5. The mobile robot according to claim 1, wherein the plurality of propulsion units are arranged in line symmetry or point symmetry with respect to the main body portion when viewed from the direction of gravity of the main body portion.

6. The mobile robot according to claim 1, wherein the plurality of support portions are a plurality of leg portions attached to the main body portion so as to be capable of supporting the weight of the main body portion.

7. The mobile robot according to claim 6, wherein the plurality of support portions further comprise a holding portion capable of holding an object, or the object held by the holding portion so as to be capable of coming into contact with the predetermined contact surface.
